(19) United States
(12) Patent Application Publication
(10) Pub. No.: US 2024/0216721 A1
(43) Pub. Date: Jul. 4, 2024

(54) MACHINE INTERLOCKED SAFETY HARNESS WITH OPERATOR SENSING

(71) Applicant: Ballymore Company, Inc., Coatesville, PA (US)

(72) Inventors: William F Frame, Coatesville, PA (US); Christopher M Orlando, Media, PA (US); John M Sayles, West Chester, PA (US)

(21) Appl. No.: 18/512,892

(22) Filed: Nov. 17, 2023

Related U.S. Application Data
(60) Provisional application No. 63/384,361, filed on Nov. 18, 2022.

(51) Int. Cl. A62B 35/00; G08B 21/02

(52) U.S. Cl. CPC A62B 35/0025; G08B 21/02

(57) ABSTRACT

A safety harness for an operator of a machine includes an air bladder attached to the safety harness such that the bladder is positioned between the operator and the harness. A pressure sensor is connected to the pressure sensor. A comparator circuit receives an output voltage of the pressure sensor and compares it to a reference voltage setpoint. When the safety harness is not worn by the operator the voltage output of the air pressure sensor is below the threshold reference voltage of the comparator circuit and when the safety harness is worn and tensioned the air bladder results in an increase in the output voltage from the air pressure sensor to determine whether the safety harness is being worn to switch the machine interlock when the operator is safely fastened into the harness.

### CROSS REFERENCE TO RELATED APPLICATIONS

This application also claims the benefit of U.S. Provisional Application No. 63/384,361, filed Nov. 18, 2022. The entire disclosure of which is incorporated herein by reference.

### STATEMENT REGARDING FEDERALLY SPONSORED RESEARCH OR DEVELOPMENT

The present invention was not developed with the use of any Federal Funds, but was developed independently by the inventors.

### BACKGROUND

### 1. Field

The present invention relates to a safety harness, and more specifically to a machine interlocked safety harness with operator sensing.

### 2. Background

Safety harnesses are used in various applications to protect the user from injury including lifts, bucket trucks, stock Picking lifts, mobile work platforms, fall protection, and the like.

Existing safety belt interlocking schemes may only rely on the belt being attached to the machine's anchor point without guaranteeing there is a body inside the harness. It would be advantageous, therefore, to provide a safety harness having an air bladder used for sensing the operator also provides ergonomic support of the lumbar spine for comfort and support during lifting/moving. It would also be advantageous to provide a safety harness that is more comfortable to wear than a standard harness. The present invention also provides an interlock to an existing system or as a standalone alarm system with its own battery source.

### SUMMARY

In one embodiment of the present invention, a safety harness for an operator of an associated machine is provided and includes an air bladder attached to the safety harness such that the bladder is positioned between the operator and the safety harness. A pressure sensor is connected to the pressure sensor via tubing and has an output voltage. A machine interlock is connected to an associated machine. A comparator circuit has an adjustable reference voltage setpoint, the comparator circuit receives the output voltage of the pressure sensor and compares it to a reference voltage setpoint wherein when the safety harness is not worn by an operator, the voltage output of the air pressure sensor is below the threshold reference voltage of the comparator circuit and when the safety harness is worn and tensioned on the operator the air bladder resulting in an increase in the output voltage from the air pressure sensor to determine whether the safety harness is being worn to switch the machine interlock when the operator is safely fastened into the harness. The air bladder may be partially filled with a pressurizing fluid such as air or a foam.

In one form of the invention, an alarm may be provided and configured to be sounded if the operator removes the safety harness while an associated machine is in operation.

### BRIEF DESCRIPTION OF THE DRAWINGS

The embodiments will be described in detail with reference to the following drawings in which like reference numerals refer to like elements wherein:

FIG. 1 is a top plan view of a safety harness or belt in accordance with the present invention.

FIG. 2 is a bottom plan view of the safety harness or belt described in accordance with FIG. 1.

FIG. 3 is the safety harness or belt of FIG. 1 being worn by a user or operator.

FIG. 4 is an alternate embodiment of the safety harness or belt of the present invention being worn by an operator or user.

FIG. 5 is a top view of a second alternate safety harness or belt in accordance with the present invention.

FIG. 6 is a side view of the safety harness or belt described in accordance with FIG. 5.

FIG. 7 is the interlock relay of the safety harness or belt of FIG. 4.

### DETAILED DESCRIPTION

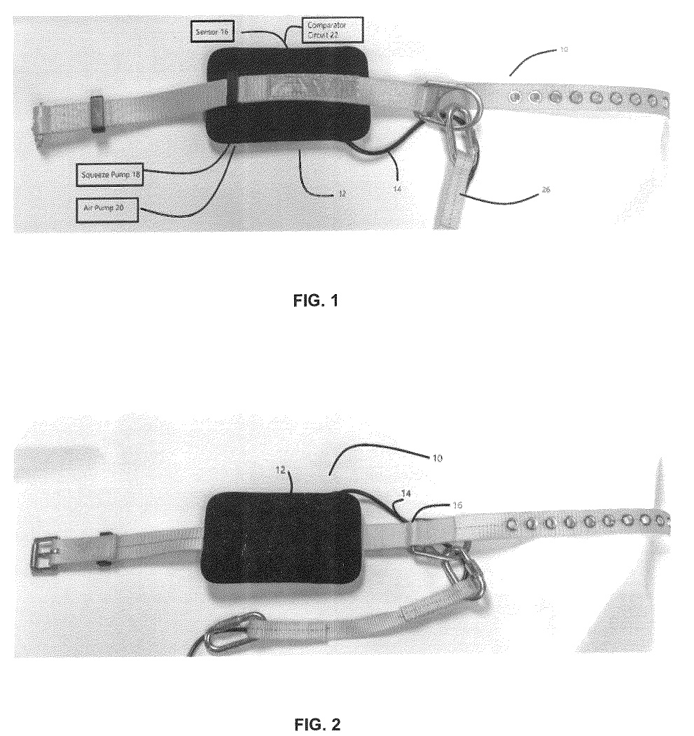

Referring now to FIGS. 1-3, A safety harness or belt 10 in accordance with the present invention is shown. The construction field safety harness or belt 10 detects when it is worn by an operator. When combined with machine interlocks and/or alarms, the safety harness or belt 10 prevents fall injuries when the operator unclips or removes the harness while elevated or while the machine is operating.

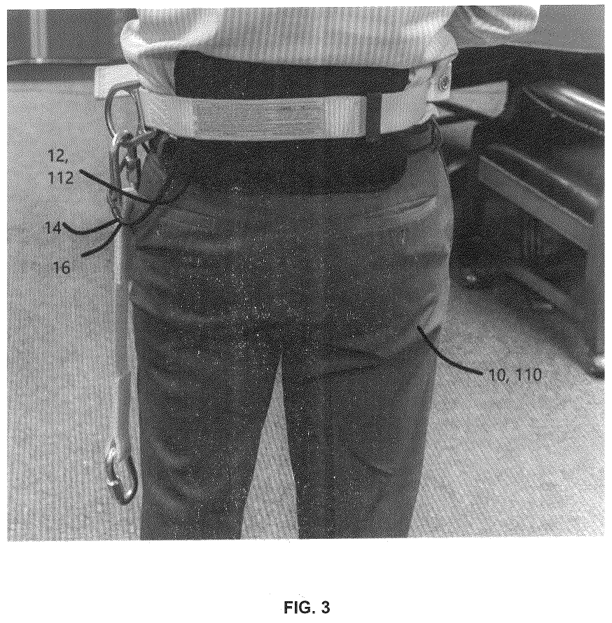

The safety harness 10 includes an air bladder 12 which is attached to the safety harness 10, preferably by a sewn connection but other similar connections are also suitable, such that the bladder 12 is positioned between the operator 100 (FIG. 3) and the safety harness 10.

The safety harness 10 is worn so the bladder 12 is located at the lumber spine of the user. The air bladder 12 is connected via tubing 14 to a pressure sensor 16. The air bladder 12 is partially inflated using a squeeze bulb 18, an air pump 20 or other suitable inflation device.

The voltage output of the air pressure sensor 16 is fed into a voltage comparator circuit 22. The comparator circuit 22 includes a reference voltage setpoint that is adjustable. The comparator circuit 22 is adjusted or configured so that the when the safety harness 10 is not worn by an operator, the voltage output of the air pressure sensor 16 is below the threshold reference voltage of the comparator circuit 22. Similarly, when the safety harness 10 is worn and tensioned on the operator, the air bladder 12 decreases in volume. This decrease in volume is accompanied by an increase in pressure. This increase in pressure results in an increase in the output voltage from the air pressure sensor 16. In this way, the output voltage of the air pressure sensor 16 voltage will exceed the threshold reference voltage in the comparator circuit 22.

Thus, the comparator circuit 22 may be used to switch a machine interlock 24 when the operator is safely fastened into the harness 10. Similarly, an alarm 26 may be sounded if the operator 100 were to remove the safety harness 100 while an associated machine is in operation.

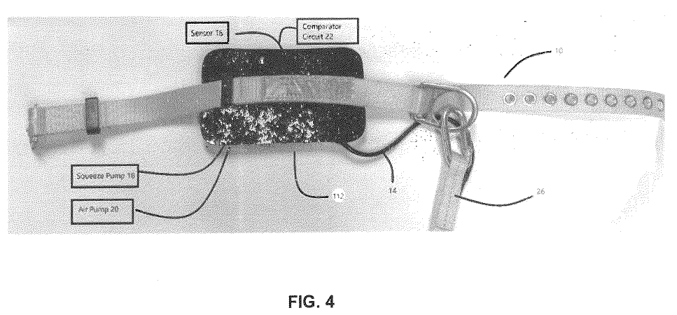

An alternate implementation of the safety harness 110 is shown in FIG. 4 having a similar bladder 116 filled with foam at atmospheric pressure. This implementation contains fewer parts and is less sensitive to air leaks that air bladder 12. In this embodiment the use of a squeeze bulb 18 or air pump 20 would not be required. When the safety belt 110 is worn and tensioned on the operator, the air bladder 116 decreases in volume. This decrease in volume is accompanied by an increase in pressure. This increase in pressure will result in an increase in voltage from the air pressure sensor (item 6). If the air pressure sensor 16 voltage exceeds the threshold reference voltage in the comparator circuit 18. The comparator circuit 22 may be used to switch a machine interlock 24 when the operator is safely fastened into the harness 10. Similarly, an alarm 26 may be sounded if the operator 100 were to remove the safety harness 100 while an associated machine is in operation.

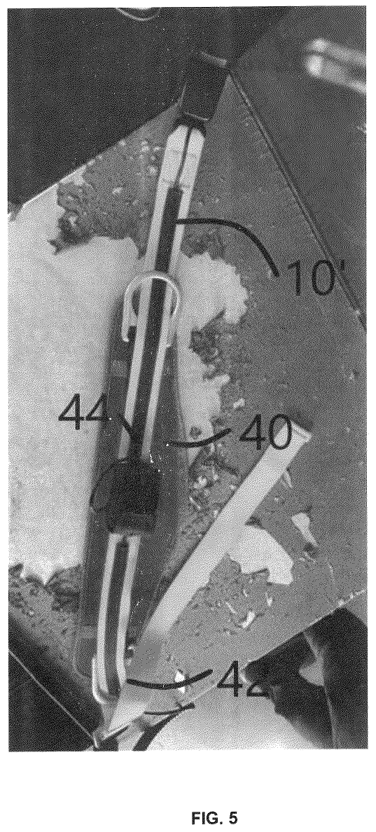

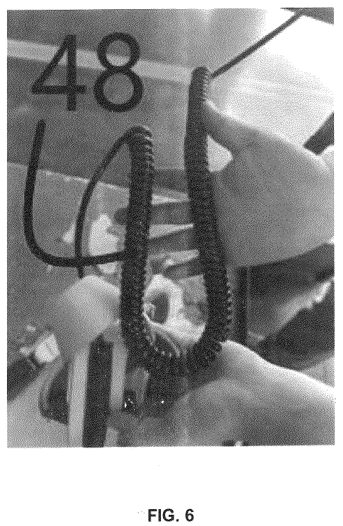

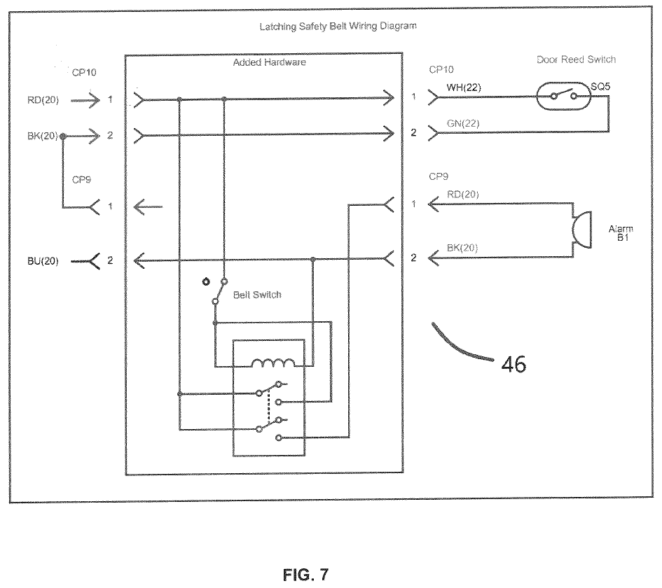

Referring now to FIGS. 5-7, A second alternate embodiment of a safety harness or belt 10′ in accordance with the present invention is shown. A back support 40 is sewn to a safety harness 10′ such that the back support 40 is between the operator 100 and the belt 10′. The belt 10′ is worn so the back support 40 is at the lumber spine. The belt 10′ contains a buckle 42 with a switch 44. This switch 44 detects if the buckle 42 is fastened. The buckle switch 44 is connected to a latching relay device 46. The latching relay 46 output may be used for a machine interlock 26. When the operator 100 is safely fastened into the harness 10′ and the machine can be operated. If the operator 100 were to remove the harness 10′ while the machine is in operation, the machine interlock 48 can stop motion, and or sound an alarm.

Other safety belt interlocking schemes may only rely on the belt being attached to the machine's anchor point without guaranteeing there is a body inside the harness. The belt's padding also provides ergonomic support of the lumbar spine for comfort and support during lifting/moving. The harness is more comfortable to wear than a standard harness. The system can applied to interlock an existing system or as a standalone alarm system with its own battery source. Applications include: Lifts, Bucket trucks, Stock Picking lifts, Mobile work platforms, Fall protection, Construction field safety, and the like.

Although embodiments have been described with reference to a number of illustrative embodiments thereof, it should be understood that numerous other modifications and embodiments can be devised by those skilled in the art that will fall within the spirit and scope of the principles of this disclosure. More particularly, various variations and modifications are possible in the component parts and/or arrangements of the subject combination arrangement within the scope of the disclosure, the drawings and the appended claims. In addition to variations and modifications in the component parts and/or arrangements, alternative uses will also be apparent to those skilled in the art.

What is claimed is:

1. A safety harness comprising for an operator of an associated machine:
an air bladder attached to the safety harness such that the bladder is positioned between the operator and the safety harness;
a pressure sensor connected to the pressure sensor via tubing the pressure sensor having an output voltage;
a machine interlock connected to an associated machine;
a comparator circuit having an adjustable reference voltage setpoint, the comparator circuit receives the output voltage of the pressure sensor and compares it to a reference voltage setpoint wherein when the safety harness is not worn by an operator, the voltage output of the air pressure sensor is below the threshold reference voltage of the comparator circuit and when the safety harness is worn and tensioned on the operator the air bladder resulting in an increase in the output voltage from the air pressure sensor to determine whether the safety harness is being worn to switch the machine interlock when the operator is safely fastened into the harness.

2. A safety harness as set forth in claim 1, further including an alarm configured to be sounded if the operator removes the safety harness while an associated machine is in operation.

3. A safety harness as set forth in claim 1, wherein the air bladder is pressurized with air.

4. A safety harness as set forth in claim 1, wherein the air bladder is pressurized with foam.

5. A safety harness as set forth in claim 3, further including an alarm configured to be sounded if the operator removes the safety harness while an associated machine is in operation.

6. A safety harness as set forth in claim 4, further including an alarm configured to be sounded if the operator removes the safety harness while an associated machine is in operation.

7. A safety harness comprising for an operator of an associated machine:
an air bladder attached to the safety harness such that the bladder is positioned between the operator and the safety harness;
a back support;
a buckle containing a switch to detects when the buckle is fastened, the buckle switch is connected to a latching relay device, the latching relay having an output to a machine interlock connected to an associated machine;
whereby the activation of the switch determines whether the buckle is fastened and the safety harness is being worn to switch the machine interlock when the operator is safely fastened into the harness.

8. A safety harness as set forth in claim 6, further including an alarm configured to be sounded if the operator removes the safety harness while an associated machine is in operation.
